(19) United States
(12) Patent Application Publication
(10) Pub. No.: US 2015/0304290 A1
(43) Pub. Date: Oct. 22, 2015

(54) ELECTRONIC DEVICES AND METHODS FOR NEAR FIELD COMMUNICATION

(71) Applicant: MediaTek Inc., Hsin-Chu (TW)

(72) Inventor: Hao-Jung LI, Zhubei City (TW)

(21) Appl. No.: 14/687,285

(22) Filed: Apr. 15, 2015

Related U.S. Application Data
(60) Provisional application No. 61/980,756, filed on Apr. 17, 2014.

(51) Int. Cl. H04L 29/06; G06F 3/0488; H04W 4/00

(52) U.S. Cl. CPC H04L 63/0492; H04W 4/008; G06F 3/0488

(57) ABSTRACT

An electronic device includes a secure element, a touch sensor and a touch sensor controller. The secure element generates a security code for a trusted transaction. The touch sensor includes transmitting electrodes and receiving electrodes configured for sensing touch events on a touch-sensitive area of the electronic device. The touch sensor controller is coupled to the secure element and the touch sensor and controls operations of the touch sensor. The secure element further transmits the security code to the touch sensor controller and the touch sensor controller transmits the security code via the transmitting electrodes.

### CROSS REFERENCE TO RELATED APPLICATIONS

This application claims the benefit of U.S. Provisional Application No. 61/980,756 filed 2014 Apr. 17 and entitled “Near Field mobile payment system with security element” and the entire contents of which are hereby incorporated by reference.

### BACKGROUND OF THE INVENTION

1. Field of the Invention

The invention relates to electronic devices and methods for near field communication with enhanced security.

2. Description of the Related Art

In the field of computing, a user may be required to input confidential information on a system or request some information from the system for different reasons. In one example, the user may be required to type in a username and password when initially logging into a computer or computer network. In another example, the user may have to manually provide a username and password when logging into certain websites on the system. In yet another example, the user may be required to provide credit card information when shopping online on the system. In yet another example, the user may input some request to try to receive interested data or information from the system

In the above examples, the inputting of authentication information or requests can be inconvenient for the user and insecure for the system. Thus, it is worth developing devices and methods that are beneficial by lessening the burden on the user and increasing system security.

### BRIEF SUMMARY OF THE INVENTION

Electronic devices and methods for near field communication are provided. An exemplary embodiment of an electronic device comprises a secure element, a touch sensor and a touch sensor controller. The secure element generates a security code for a trusted transaction. The touch sensor comprises a plurality of transmitting electrodes and a plurality of receiving electrodes configured for sensing touch events on a touch-sensitive area of the electronic device. The touch sensor controller is coupled to the secure element and the touch sensor and controls operations of the touch sensor. The secure element further transmits the security code to the touch sensor controller and the touch sensor controller transmits the security code via the transmitting electrodes.

An exemplary embodiment of a near field communication method for use in an electronic device with at least a secure element to ensure security comprises: generating a security code for a trusted transaction by the secure element; and transmitting the security code to an air interface via a plurality of transmitting electrodes of the electronic device.

A detailed description is given in the following embodiments with reference to the accompanying drawings.

### BRIEF DESCRIPTION OF DRAWINGS

The invention can be more fully understood by reading the subsequent detailed description and examples with references made to the accompanying drawings, wherein:

FIG. 1 shows an exemplary block diagram of an electronic device according to an embodiment of the invention;

FIG. 2 shows an exemplary block diagram of an electronic device according to another embodiment of the invention;

FIG. 3 shows an exemplary block diagram of an electronic device according to yet another embodiment of the invention;

FIG. 4 shows an exemplary block diagram of an electronic device according to yet another embodiment of the invention;

FIG. 5 is a flow chart of a near field communication method for using in an electronic device with at least a secure element to ensure security according to an embodiment of the invention;

FIG. 6A shows an exemplary placement of two electronic devices in a near field communication system according to an embodiment of the invention;

FIG. 6B shows another exemplary placement of two electronic devices in a near field communication system according to another embodiment of the invention;

FIG. 6C shows yet another exemplary placement of two electronic devices in a near field communication system according to yet another embodiment of the invention;

FIG. 6D shows still another exemplary placement of two electronic devices in a near field communication system according to still another embodiment of the invention;

FIG. 7A shows an exemplary electronic bracelet according to an embodiment of the invention;

FIG. 7B shows an exemplary smart watch according to an embodiment of the invention;

FIG. 8 is a schematic diagram showing a near field communication system according to another embodiment of the invention; and

FIG. 9 is a schematic diagram showing a near field communication system according to yet another embodiment of the invention.

### DETAILED DESCRIPTION OF THE INVENTION

The following description is of the best-contemplated mode of carrying out the invention. This description is made for the purpose of illustrating the general principles of the invention and should not be taken in a limiting sense. The scope of the invention is best determined by reference to the appended claims.

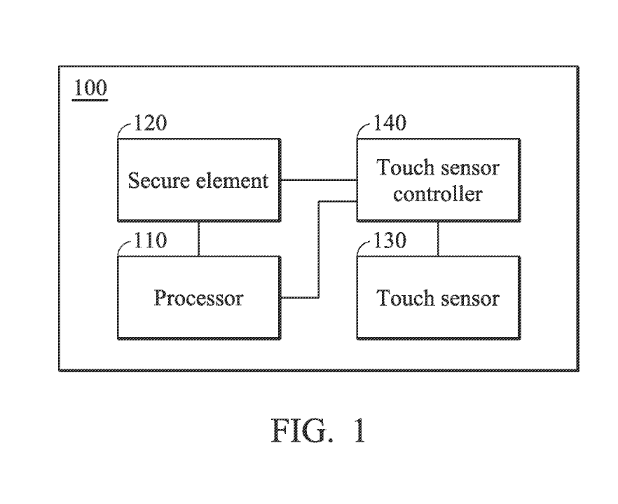

FIG. 1 shows an exemplary block diagram of an electronic device according to an embodiment of the invention. According to an embodiment of the invention, the electronic device 100 may comprise a processor 110, a secure element 120, a touch sensor 130 and a touch sensor controller 140. In order to clarify the concept of the invention, FIG. 1 presents a simplified block diagram, in which only the elements relevant to the embodiments of the invention are shown. However, note that the invention should not be limited what is shown in FIG. 1.

The processor 110 may be a general-purpose microprocessor, a microcontroller (MCU) or a central processing unit (CPU) for controlling operations of the whole system of the electronic device 100. The touch sensor 130 may comprise a plurality of transmitting electrodes and a plurality of receiving electrodes configured for sensing touch events on one or more touch-sensitive area(s) of the electronic device 100. The touch-sensitive area may be configured or disposed on any surface or may be configured or disposed anywhere on a housing of the electronic device 100. The touch-sensitive area is provided for a user to input commands via his finger, a stylus or the like to operate the electronic device 100. The touch sensor controller 140 is coupled to the processor 110, the secure element 120 and the touch sensor 130 and controls operations of the touch sensor 130.

The touch sensor 130 and touch sensor controller 140 may detect the presence and location of a touch or the proximity of an object within the touch-sensitive area(s) of the touch sensor 130. Herein, reference to a touch sensor may encompass both the touch sensor and its touch sensor controller, where appropriate. Similarly, reference to a touch sensor controller may encompass both the touch sensor controller and its touch sensor, where appropriate. The touch sensor 130 may comprise one or more touch-sensitive areas.

The transmitting electrodes and receiving electrodes may be made of dielectric materials. As an example and not by way of limitation, an electrode may be made of indium tin oxide (ITO). As another example and not by way of limitation, an electrode may be made of fine lines of metal or other conductive material, such as for example copper, silver, or a copper- or silver-based material. In addition, the touch sensor 130 may implement a capacitive form or a resistive form of touch sensing.

The touch-sensitive area may be composed of a plurality of sensing nodes, which may form a sensing array, or any other shape. A change in capacitance or resistance on a sensing node of the touch-sensitive area(s) may indicate a touch or proximity input at the position of the sensing node. By measuring changes in capacitance or resistance on the touch-sensitive area(s), touch sensor controller 140 may determine the position of the touch or proximity within the touch-sensitive area(s).

The touch sensor controller 140 may then communicate information about the touch or proximity input to one or more other components (such as the processor 110) of the electronic device 100, which may respond to the touch or proximity input by initiating a function of the electronic device 100 (or an application running on the electronic device 100).

The touch sensor controller 140 may be one or more integrated circuits (ICs). In some embodiments, the touch sensor controller 140 may comprise analog circuitry, digital logic, and digital non-volatile memory. In addition, the touch sensor controller 140 may supply drive signals to the transmitting and receiving electrodes of touch sensor 130. Note that although this disclosure describes a touch sensor controller having a particular implementation with particular components, this disclosure contemplates any suitable touch sensor controller having any suitable implementation with any suitable components.

The secure element 120 may be configured for authentication, storage and processing in trusted transactions that requires a high security level to protect sensitive data, programs or applications in a trusted environment. The sensitive data may comprise personal identity, payment signature, account numbers, access codes, cryptographic keys and certificates, and other information. These trusted transactions may comprise bank account management, purchasing orders, passport verification, and many other high-security applications.

According to an embodiment of the invention, the electronic device 100 may be implemented as any type of electronic device, such as a wearing device, a smart watch, an electronic bracelet, or any type of portable or handheld electronic device. The proposed near field communication methods carried out by such an electronic device as illustrated above to ensure security will be discussed in the following paragraphs.

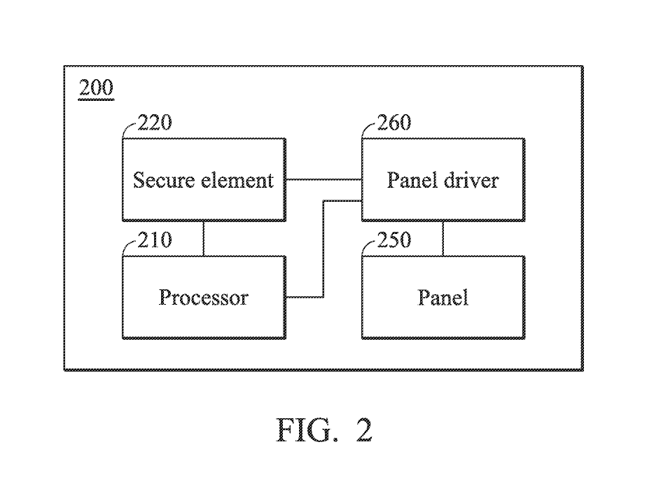

FIG. 2 shows an exemplary block diagram of an electronic device according to another embodiment of the invention. According to an embodiment of the invention, the electronic device 200 may comprise a processor 210, a secure element 220, a panel 250 and a panel driver 260. In order to clarify the concept of the invention, FIG. 2 presents a simplified block diagram, in which only the elements relevant to the embodiments of the invention are shown. However, note that the invention should not be limited what is shown in FIG. 2.

The processor 210 and secure element 220 in the electronic device 200 substantially operate in a similar way as the processor 110 and secure element 120 in the electronic device 100. Therefore, for the descriptions of the similar parts, reference may be made to FIG. 1 and are omitted here for brevity.

In the embodiment, the panel 250 is configured for displaying image data. The panel 250 may be an LCD panel, an LED panel, or others. The panel driver 260 is coupled to the processor 210, the secure element 220 and the panel 250 and drives the panel 250. The panel driver 260 may be one or more integrated circuits (ICs). In some embodiments, the panel driver 260 may comprise analog circuitry, digital logic, and digital non-volatile memory. In addition, the panel driver 260 may supply drive signals and data signals to the panel 250.

In addition, in some embodiments of the invention, the panel 250 may further comprise a plurality of transmitting electrodes and selectively comprise a plurality of receiving electrodes. For example, the panel 250 may be implemented as a panel with or without touch-control functionality. In addition, in some embodiments of the invention, the panel 250 may be implemented as a panel without display functionality. In addition, the panel 250 may be implemented as a non-transparent panel or a transparent panel.

According to an embodiment of the invention, the electronic device 200 may be implemented as any type of electronic device, such as a wearing device, a smart watch, an electronic bracelet, a mobile phone, a tablet, an exhibition window with image display functionality for exhibiting some products and may be able to interact with user, or any type of portable or handheld electronic device. The proposed near field communication methods carried out by such electronic devices as illustrated above to ensure security will be discussed in the following paragraphs.

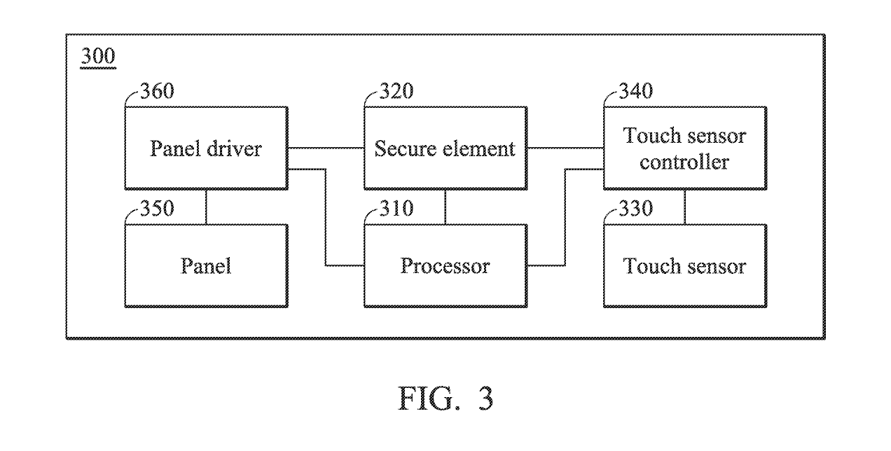

FIG. 3 shows an exemplary block diagram of an electronic device according to yet another embodiment of the invention. According to an embodiment of the invention, the electronic device 300 may comprise a processor 310, a secure element 320, a touch sensor 330, a touch sensor controller 340, a panel 350 and a panel driver 360. In order to clarify the concept of the invention, FIG. 3 presents a simplified block diagram, in which only the elements relevant to the embodiments of the invention are shown. However, note that the invention should not be limited what is shown in FIG. 3.

The processor 310, the secure element 320, the touch sensor 330, the touch sensor controller 340, the panel 350 and the panel driver 360 in the electronic device 300 substantially operate in a similar way as the processor 110, the secure element 120, the touch sensor 130 and the touch sensor controller 140 in the electronic device 100 and the processor 210, the secure element 220, the panel 250 and the panel driver 260 in the electronic device 200. Therefore, for the descriptions of the similar parts, reference may be made to FIG. 1 and FIG. 2 and are omitted here for brevity.

According to an embodiment of the invention, the electronic device 300 may be implemented as any type of electronic device, such as a wearing device, a smart watch, an electronic bracelet, a mobile phone, a tablet, an exhibition window with image display functionality for exhibiting some products and may be able to interact with user, or any type of portable or handheld electronic device. The proposed near field communication methods carried out by such electronic devices as illustrated above to ensure security will be discussed in the following paragraphs.

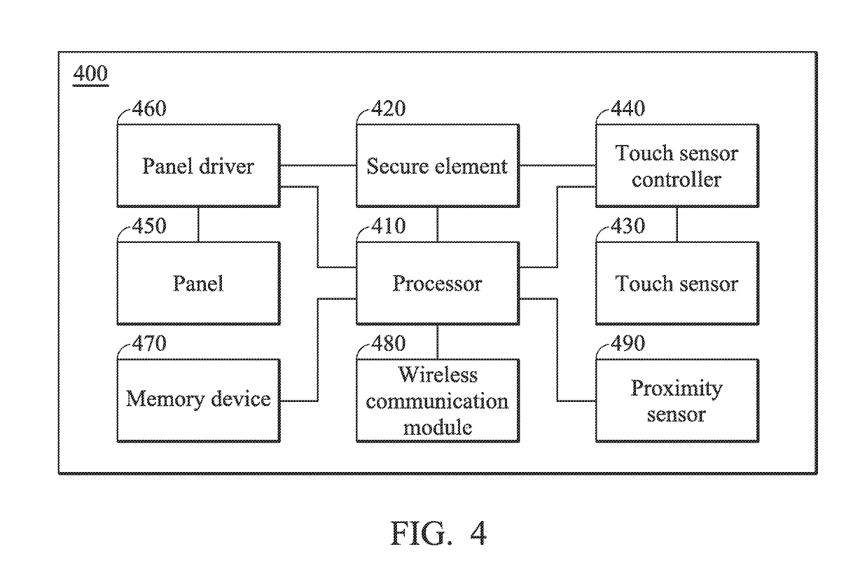

FIG. 4 shows an exemplary block diagram of an electronic device according to yet another embodiment of the invention. According to an embodiment of the invention, the electronic device 400 may comprise a processor 410, a secure element 420, a touch sensor 430, a touch sensor controller 440, a panel 450, a panel driver 460, a memory device 470, a wireless communication module 480 and a proximity sensor 490. In order to clarify the concept of the invention, FIG. 4 presents a simplified block diagram, in which only the elements relevant to the embodiments of the invention are shown. However, note that the invention should not be limited what is shown in FIG. 4.

The processor 410, the secure element 420, the touch sensor 430, the touch sensor controller 440, the panel 450 and the panel driver 460 in the electronic device 400 substantially operate in a similar way as the processor 110, the secure element 120, the touch sensor 130 and the touch sensor controller 140 in the electronic device 100 and the processor 210, the secure element 220, the panel 250 and the panel driver 260 in the electronic device 200. Therefore, for the descriptions of the similar parts, reference may be made to FIG. 1 and FIG. 2 and are omitted here for brevity.

In the embodiment, the processor 410 is further coupled to the memory device 470, the wireless communication module 480 and the proximity sensor 490 for controlling the operations thereof. The memory device 470 may be any type of memory and is configured for storing system and user data. The wireless communication module 480 may at least comprise one or more antennas (not shown), a radio transceiver (not shown), and a baseband signal processing device (not shown), and is configured for providing wireless communication services in compliance with a predetermined communication protocol, such as a Bluetooth communication protocol, a WiFi communication protocol, a 2G communication protocol, a 3G communication protocol, a 4G communication protocol, or any further advanced communication protocol that is developing or to be developed.

The baseband signal processing device may comprise multiple hardware devices to perform baseband signal processing, including Analog-to-Digital Conversion (ADC)/Digital-to-Analog Conversion (DAC), gain adjusting, modulation/demodulation, encoding/decoding, and so on. The radio transceiver may receive RF signals, process the RF signals, and convert the RF signals to baseband signals, which are to be processed by the baseband signal processing device, or receive baseband signals from the baseband signal processing device, convert the received baseband signals to RF signals and process RF signals which are later transmitted. The radio transceiver may also comprise multiple hardware devices to perform radio frequency conversion and RF signal processing. For example, the radio transceiver may comprise a mixer to multiply the baseband signals with a carrier oscillated in a radio frequency, where the radio frequency depends on the Radio Access Technology (RAT) in use.

The proximity sensor 490 may be configured to sense proximity of an external object. According to an embodiment of the invention, a touch link can only be established between the electronic device 400 and the external object when the proximity sensor 490 senses that the distance to the external object is under a predetermined threshold (for example, 5 cm), for the security reasons. The touch link will be discussed further in the following paragraph)

According to an embodiment of the invention, the electronic device 400 may be implemented as any type of electronic device, such as a wearing device, a smart watch, an electronic bracelet, a mobile phone, a tablet, an exhibition window with image display functionality for exhibiting some products and may be able to interact with user, or any type of portable or handheld electronic device. The proposed near field communication methods carried out by such electronic devices as illustrated above to ensure security will be discussed in the following paragraphs.

According to an embodiment of the invention, when the processor (such as the processor 110, 210, 310 and/or 410) is processing a trusted transaction or any application that requires a high security level to protect the corresponding data or information in a trusted environment, the processor may determine that the electronic device (such as the electronic device 100, 200, 300 and/or 400) has to enter a security mode for the trusted transaction or application and transmit a request for the trusted transaction or application to the secure element (such as the secure element 120, 220, 320 and/or 420) so as to activate the secure element.

Upon receiving the request, the secure element may generate a security code for the trusted transaction or application in response to the request. According to an embodiment of the invention, the security code may be a one dimensional binary code, a two dimensional binary code, etc. . . . For example, the security code may be a Quick Response (QR) code. In addition, in some embodiments of the invention, the security code may embed information regarding a one-time password (OTP), a personal identity or a payment signature. That is, the security code may be related to the owner of the electronic device or is a trusted universal code for personal identity or a payment signature. In addition, in some embodiments of the invention, the security code may embed information regarding the trusted transaction or application.

According to an embodiment of the invention, the processor may transmit the information regarding the trusted transaction or application and/or information regarding the personal identity or the payment signature that is unique to the owner of the electronic device to the secure element. For example, the processor may carry the information in the request or in other message(s).

After generating the security code, the secure element may further transmit the security code to other component of the electronic device, such as the transmitting electrodes comprised in the panel (such as the panel 250, 350, and/or 450), the touch sensor (such as the touch sensor 130, 330, and/or 430), the touch sensor controller (such as the touch sensor controller 140, 340, and/or 440), etc. . . .

According to an embodiment of the invention, upon receiving the security code, the corresponding component, such as the transmitting electrodes, the touch sensor, or the touch sensor controller may further transmit the security code to the air interface. An external object in proximity to the electronic device and participating in the trusted transaction or application may then receive the security code and further process or complete the trusted transaction or application according to the security code.

According to an embodiment of the invention, since the touch sensor is capable of sensing touch events on the touch-sensitive area(s) of the electronic device, the trusted transaction and application that requires a high security level to protect the corresponding data or information in a trusted environment may be triggered by a touch event sensed by the touch sensor. Note that in other embodiments of the invention, the transaction and application may also be triggered by any other event, and the invention should not be limited thereto.

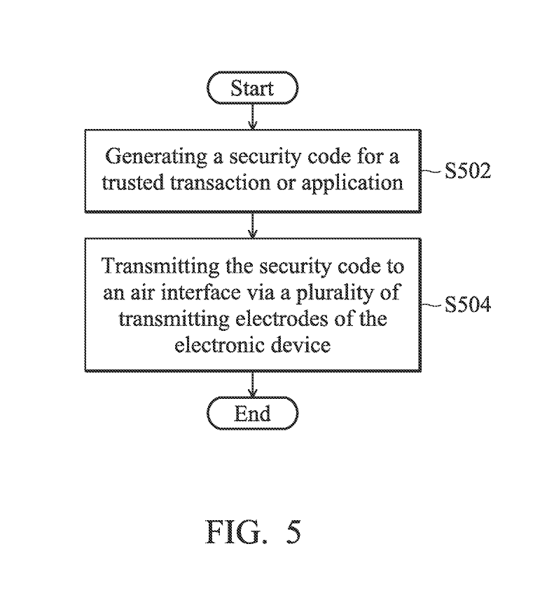

FIG. 5 is a flow chart of a near field communication method for using in an electronic device with at least a secure element to ensure security according to an embodiment of the invention. First of all, a security code is generated by the secure element for a trusted transaction or application (Step S502). Next, the security code to an air interface via a plurality of transmitting electrodes of the electronic device (Step S504).

According to an embodiment of the invention, in the security mode, the touch sensor controller is controlled by the secure element. In addition, according to an embodiment of the invention, the security code may be transmitted by the transmitting electrodes of the electronic device based on a touch link technology. In an embodiment of the invention, a touch link can be established between the electronic device and the external object when these two devices are placed close enough (for example, 5 cm).

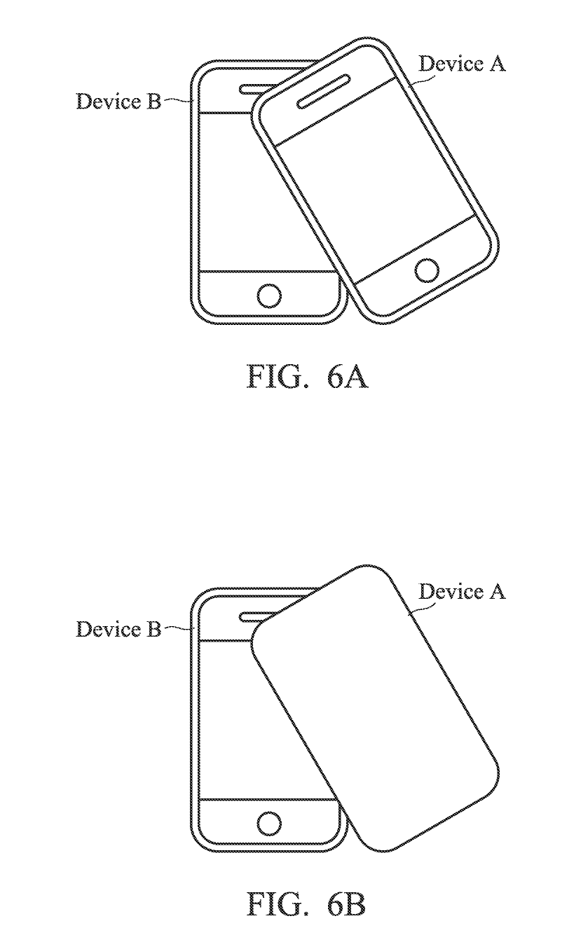

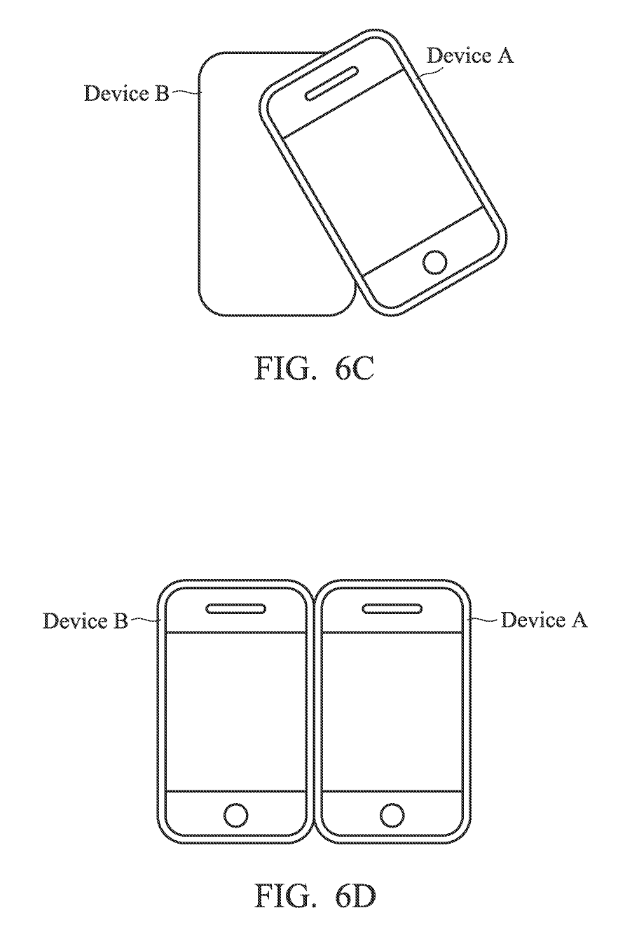

FIG. 6A to FIG. 6D show a plurality of exemplary placements of two electronic devices in a near field communication system according to different embodiments of the invention. According to an embodiment of the invention, the processor of one electronic device (for example, Device A) may transmit a request for establishing a touch link to another external electronic device (for example, Device B) to initiate a handshake procedure. Because Device B is brought into physical proximity with Device A, the electromagnetic fields associated with the electrodes within the touch sensor(s) or panel(s) of the two electronic devices may interact. Therefore, Device B may receive the request from Device A via its receiving electrodes. After receiving the request, the processor of Device B may generate a response for responding to the request, and transmit the response to Device A via its transmitting electrodes, so as to participate in the handshake procedure. In the handshake procedure, the electronic device 210 and the electronic device 220 may exchange essential information, such as the security code as discussed above, or exchange other essential information as required, based on the touch link technology.

Note that in some embodiments of the invention, Device B may further check whether a key for near field communication exists (and/or matches a predetermined value) before responding to the request, and generate the response when the key exists. Note further that in some embodiments of the invention, the processor of Device B may optionally play a sound or trigger a vibration to notify the user that a request from another electronic device has been received. Note further that although the mobile phones are used as examples of the two electronic devices shown in FIG. 6A to FIG. 6D, the invention should not be limited thereto.

For further illustration regarding touch link technology, reference may be made to the corresponding patent applications US 2011/0304583, US 2013/0147760, and CN 102916729A, and are omitted here for brevity.

According to another embodiment of the invention, in the security mode, the panel driver (such as the panel driver 260, 360 and/or 460) may also be controlled by the secure element. In addition, the secure element may further transmit the security code to the panel driver and the panel driver may then drive the panel to display the security code.

As discussed above, the proposed near field communication method may be implemented in the proposed electronic device, and the proposed electronic device may be implemented as any type of electronic device, such as a wearing device, a smart watch, an electronic bracelet, a mobile phone, a tablet, an exhibition window with image display functionality for exhibiting some products and may be able to interact with user, or any type of portable or handheld electronic device.

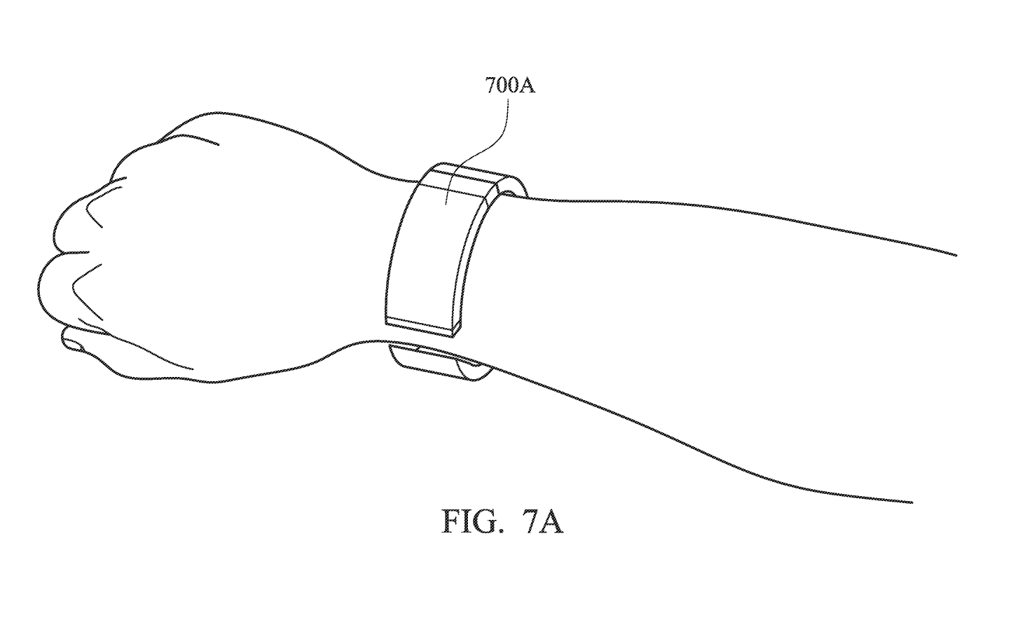

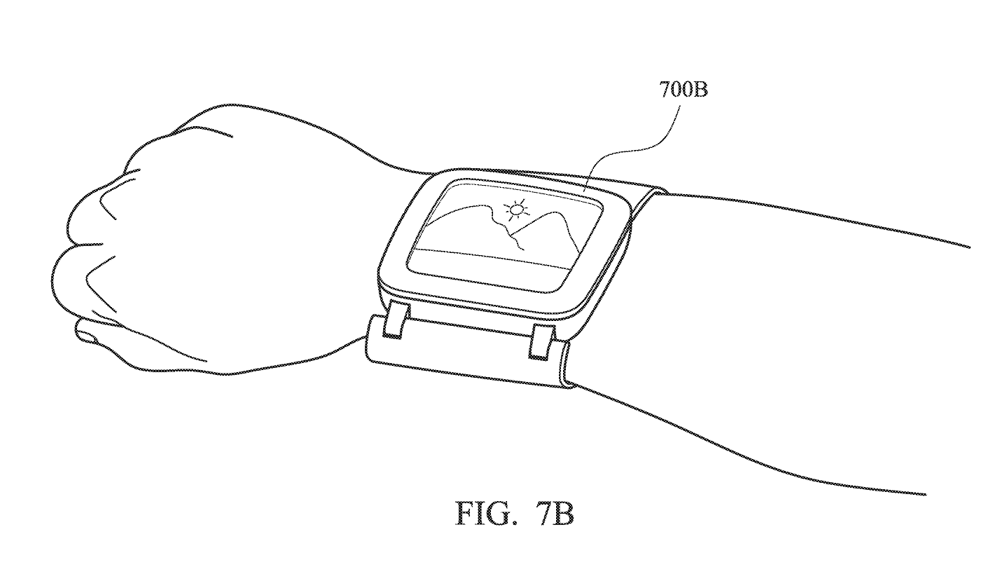

FIG. 7A shows an exemplary electronic bracelet according to an embodiment of the invention. The electronic bracelet 700A may at least comprise a processor, a secure element and a plurality of transmitting electrodes as described above to implement the proposed near field communication method. In some embodiments of the invention, the electronic bracelet 700A may also be implemented as to have touch-control functionality and further comprise a plurality of receiving electrodes, a touch sensor and a corresponding touch sensor controller as described above. In some embodiments of the invention, the electronic bracelet 700A may also be implemented to have display functionality and further comprise a display panel and a corresponding panel driver as described above.

FIG. 7B shows an exemplary smart watch according to an embodiment of the invention. The electronic bracelet 700B may at least comprise a processor, a secure element, a display panel, a corresponding panel driver and a plurality of transmitting electrodes as described above to implement the proposed near field communication method. In some embodiments of the invention, the electronic bracelet 700A may also be implemented to have touch-control functionality and further comprise a plurality of receiving electrodes, a touch sensor and a corresponding touch sensor controller as described above.

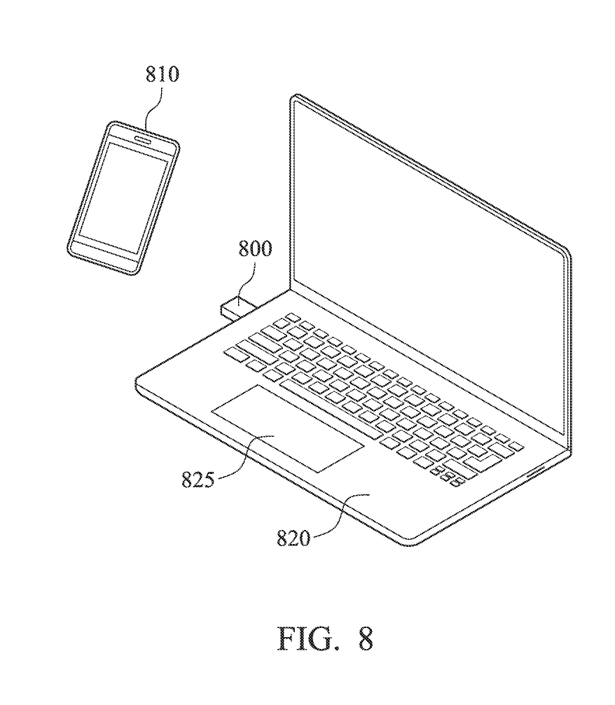

FIG. 8 is a schematic diagram showing a near field communication system according to another embodiment of the invention. The near field communication system may comprise a dongle device 800, a first electronic device 810 and a second electronic device 820 connected to the dongle device 800. For example, the dongle device 800 may be plugged into a socket of the second electronic device 820. In this embodiment, the proposed electronic device may be the dongle device 800, the first electronic device 810 and/or the second electronic device 820.

When the proposed electronic device is implemented as the dongle device 800, the security code may be generated by the secure element comprised in the dongle device 800 and transmitted via the transmitting electrodes comprised in the dongle device 800. When the proposed electronic device is implemented as the first electronic device 810, which may be a mobile phone with touch-control functionality and display functionality, the security code may be generated by the secure element comprised in the first electronic device 810 and transmitted via the transmitting electrodes of the touch sensor or touch-controlled panel comprised in the first electronic device 810. In addition, the security code may also be displayed via the touch-controlled panel of the first electronic device 810.

When the proposed electronic device is implemented as the second electronic device 820, which may be a personal computer with touch-control functionality and display functionality, the security code may be generated by the secure element comprised in the second electronic device 820 and transmitted via the transmitting electrodes of the mouse tracking pad 825. In addition, the security code may also be displayed via the display panel of the second electronic device 820.

Therefore, the trusted transaction or application may be processed in the near field communication system as shown in FIG. 8 among those electronic devices based on the proposed near field communication method to ensure security.

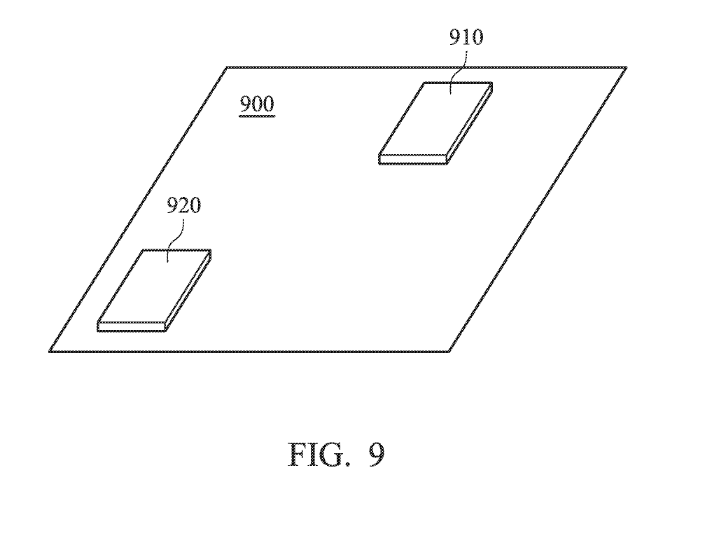

FIG. 9 is a schematic diagram showing a near field communication system according to yet another embodiment of the invention. The near field communication system may comprise electronic devices 900, 910 and 920. In this embodiment, the proposed electronic device may be the electronic devices 900, 910 and/or 920. The electronic device 900 may be an exhibition window for exhibiting some products and may comprise at least a processor, a secure element, a display panel, a corresponding panel driver and a plurality of transmitting electrodes to implement the proposed near field communication method. The electronic devices 910 and 920 can be any type of handheld electronic devices, such as a mobile phone, a tablet, or others.

When the proposed electronic device is implemented as the electronic device 900, the security code may be generated by the secure element comprised in the electronic device 900 and transmitted via the transmitting electrodes comprised in the electronic device 900. In some embodiments of the invention, the electronic device 900 may also be implemented as to have touch-control functionality and may further comprise a plurality of receiving electrodes, a touch sensor and a corresponding touch sensor controller as described above.

When the proposed electronic device is implemented as the electronic device 910/920, which may have touch-control functionality and display functionality, the security code may be generated by the secure element comprised in the electronic device 910/920 and transmitted via the transmitting electrodes of the touch sensor or touch-controlled panel comprised in the electronic device 910/920. In addition, the security code may also be displayed via the touch-controlled panel of the electronic device 910/920.

Therefore, the trusted transaction or application may be processed in the near field communication system as shown in FIG. 9 among those electronic devices based on the proposed near field communication method to ensure security.

Compared to the conventional method, by combining the operations of the secure element and the touch link technology, security of the data transmission, transaction and/or application can further be enhanced.

The above-described embodiments of the present invention can be implemented in any of numerous ways. For example, the embodiments may be implemented using hardware, software or a combination thereof. It should be appreciated that any component or collection of components that perform the functions described above can be generically considered as one or more processors that control the above discussed function. The one or more processors can be implemented in numerous ways, such as with dedicated hardware, or with general purpose hardware that is programmed using microcode or software to perform the functions recited above.

While the invention has been described by way of example and in terms of preferred embodiment, it is to be understood that the invention is not limited thereto. Those who are skilled in this technology can still make various alterations and modifications without departing from the scope and spirit of this invention. Therefore, the scope of the present invention shall be defined and protected by the following claims and their equivalents.

What is claimed is:

1. An electronic device, comprising:
a secure element, generating a security code for a trusted transaction;
a touch sensor, comprising a plurality of transmitting electrodes and a plurality of receiving electrodes configured for sensing touch events on a touch-sensitive area of the electronic device; and
a touch sensor controller, coupled to the secure element and the touch sensor and controlling operations of the touch sensor,
wherein the secure element further transmits the security code to the touch sensor controller and the touch sensor controller transmits the security code via the transmitting electrodes.

2. The electronic device as claimed in claim 1, further comprising:
a processor, determining whether to enter a security mode for the trusted transaction and transmitting a request for the trusted transaction to the secure element when the processor determines to enter the security mode,
wherein the secure element generates the security code in response to the request.

3. The electronic device as claimed in claim 1, wherein the security code embeds information regarding a one-time password, a personal identity or a payment signature.

4. The electronic device as claimed in claim 1, wherein the security code is a one-dimensional binary code.

5. The electronic device as claimed in claim 1, wherein the security code is a two-dimensional binary code.

6. The electronic device as claimed in claim 2, wherein in the security mode, the touch sensor controller is controlled by the secure element.

7. The electronic device as claimed in claim 2, wherein the processor further transmits information regarding the trusted transaction to the secure element, and the secure element embeds the information regarding the trusted transaction in the security code.

8. The electronic device as claimed in claim 1, wherein the trusted transaction is triggered by a touch event sensed by the touch sensor.

9. The electronic device as claimed in claim 1, further comprising:
a panel, configured for display image data; and
a panel driver, coupled to the secure element and the panel and driving the panel,
wherein the secure element further transmits the security code to the panel driver and the panel driver drives the panel to display the security code.

10. The electronic device as claimed in claim 9, wherein the touch-sensitive area is configured on the panel.

11. A near field communication method for use in an electronic device with at least a secure element to ensure security, comprising:
generating a security code for a trusted transaction by the secure element; and
transmitting the security code to an air interface via a plurality of transmitting electrodes of the electronic device.

12. The near field communication method as claimed in claim 11, further comprising:
determining whether the electronic device has to enter a security mode for the trusted transaction; and
transmitting a request for the trusted transaction to the secure element when it is determined that the electronic device has to enter the security mode,
wherein the security code is generated in response to the request.

13. The near field communication method as claimed in claim 11, wherein the security code embeds information regarding a one-time password, a personal identity or a payment signature.

14. The near field communication method as claimed in claim 11, wherein the security code is a one-dimensional binary code.

15. The near field communication method as claimed in claim 11, wherein the security code is a two-dimensional binary code.

16. The near field communication method as claimed in claim 11, wherein the security code embeds information regarding the trusted transaction.

17. The near field communication method as claimed in claim 11, wherein the trusted transaction is triggered by a touch event sensed by a touch sensor of the electronic device, and wherein the touch sensor comprises the transmitting electrodes and a plurality of receiving electrodes configured for sensing touch events on a touch-sensitive area of the electronic device.

18. The near field communication method as claimed in claim 11, further comprising:
displaying the security code on a panel of the electronic device.
